(19) United States
(12) Patent Application Publication
(10) Pub. No.: US 2004/0107448 A1
(43) Pub. Date: Jun. 3, 2004

(54) Device, apparatus and method for selecting a programme from a plurality of programmes within a network

(75) Inventors: Laurent Frouin, Rennes (FR); Kenichi Nagasawa, London (GB)

Correspondence Address: FITZPATRICK CELLA HARPER & SCINTO, 30 ROCKEFELLER PLAZA, NEW YORK, NY, 10112, US

(73) Assignee: Canon Europa NV, Amstelveen (NL)

(21) Appl. No.: 10/647,344

(22) Filed: Aug. 26, 2003

(30) Foreign Application Priority Data
Sep. 6, 2002 (GB) 0220796.7

(51) Int. Cl. H04N 7/025; H04N 7/16; H04N 7/10

(52) U.S. Cl. 725/135; 725/35; 725/34; 348/460; 725/136

(57) ABSTRACT

The present invention concerns a device, an apparatus and a method for selecting a programme from a plurality of programmes which may be in a plurality of different data streams, which is able to select a programme from the plurality of programmes within the network based on operations of a manually operable means so that the specific manual operations of a single manually operable member is able to cause a selection of the programme from a plurality of programmes within one data stream and a selection of the data stream from the plurality of different data streams. Accordingly, the user of the network can select a desired programme very naturally without being conscious of the different data streams.

### FIELD OF THE INVENTION

The present invention concerns a device, apparatus and method for selecting a programme from a plurality of programmes in a network, especially for selecting a programme amongst a plurality of data streams. For example, this invention can be applied to a system called the “management” of such a network, that is to say displaying, by any chosen host, according to the requirements of the network users, any chosen programme.

### BACKGROUND OF THE INVENTION

Modern communication networks often transmit data of different natures such as video (moving images), sound, photographs (still images) and so on. Such data may be encoded according to different algorithms and may be transmitted by different formats. The transmission of these data is subject to variable requirements according to the type of data to be transmitted and the algorithm and protocol for the encoding.

For example video data can be coded according to DV format if the data come from a digital video camcorder and transmission protocol shall follow for instance SD-DVCR data transmission standard (see Consumer audio/video equipment, Digital Interface CEI/IEC 61883-2:1998) or according to MPEG2 format if the data come from a broadcasting source and transmission protocol shall follow for instance MPEG2-TS data transmission standard (see Consumer audio/video equipment, Digital Interface CEI/IEC 61883-4:1998).

SD-DVCR stands for Standard Definition Digital Video Cassette Recorder. It is sometimes abbreviated to DV.

MPEG stands for Motion Picture Expert Group and TS stands for Transport Stream. MPEG2 defines one specific motion picture compression scheme having features regarding picture resolution, frame rate and compression ratio corresponding to standard resolution 525-60 and 625-50 display systems.

The 525-60 system is a 525 line system with a frame frequency of 29.97 Hz. The 625-50 system is a 625 line system with a frame frequency of 25 Hz.

In the case of MPEG2 transport stream format, data contained in the transport stream composed of a plurality of packets can be related to a plurality of video programmes. On the other hand in the DV data stream format, data series contained in the packets are related to a single programme.

The communication network considered here are of the type comprising a plurality of sub networks, the sub networks being interconnected through bridges using bridging technology or switches using switching technology. For example, two so-called IEEE-1394 serial buses (sub networks) are interconnected by the bridging technology, such as a so-called IEEE-1394.1 bridge.

Such communication networks using the switching technology are described notably in the European patent application EP-1124357 in the name of Canon. A detailed description of the data transfer mechanisms, for example of the audio-visual type, can be found therein.

In such networks, it is important feature that, according to requirements of the network users, any selected programme among a plurality of data streams of different formats can be used for displaying, recording, or like.

However, due to the many different types of data streams, such a selection requires complex operations by the user. Further, if there are several sub networks as described, this selection has to be made in communication with other selected host computers located in other networks. Accordingly, many more user operations are required. The quantity of operations is further increased if the network is divided into several sub networks.

### SUMMARY OF THE INVENTION

This invention has been created for addressing or resolving the drawbacks described above.

One of objects of this invention is to provide an efficient and easy way for a user to select a programme from a plurality of available programmes contained in a plurality of different data streams issued from different transmission protocols in a network.

To accomplish the above object, the invention introduces, as one aspect, a device for selecting a programme from a plurality of programmes, each programme being composed of a plurality of data series, the device being used with a network which conveys a plurality of different data streams, each data stream conveying one or more programmes. Such a device comprises manually operable means including a manually operable member which allows at least one specific manual operation and means for issuing commands being able to select a programme from the plurality of programmes within the network based on the operation of the manually operable member and said issuing means is arranged to issue the commands so that the specific manual operation is able to cause, without other manual operations of said manually operable means, a selection of the programme from the one or more programmes within one data stream and a selection of the data stream, from which the programme is selected, from the plurality of different data streams.

As another aspect of this invention, this invention introduces an apparatus for selecting a programme, from a plurality of programmes, each programme being composed of a plurality of data series, the apparatus being connected to a network which conveys a plurality of different data streams, each data stream conveying one or more programmes. Such an apparatus comprises means for receiving commands based on manual operations of manually operable means including a manually operable member which allows at least one specific manual operation and means for selecting a programme from the plurality of programmes within the network based on the received commands, and said selecting means selects the programme from the one or more programmes within one data stream and further selects the data stream, from which the programme is selected, from the plurality of different data streams in response to the specific manual operation of the manually operable member without other manual operations of said manually operable means.

As further aspect of this invention, this invention introduces a method of selecting a programme from a plurality of programmes within a communication network, each programme being composed of a plurality of data series, wherein the network conveys a plurality of different data streams, each data stream conveying one or more programmes. Such a method comprises a step of issuing commands based on manual operations of manually operable means including a manually operable member which allows at least one specific manual operation and a step of selecting a programme from the plurality of programmes within the network based on the issued commands, wherein the programme is selected in said selecting step from a plurality of the one or more programmes within one data stream and the data stream, from which the programme is to be selected, is selected from the plurality of different data streams are selected in said selecting step, in response to the specific manual operation of the manual operable member without other manual operations of said manually operable means.

According to these aspects, namely device, apparatus and method, it becomes much easier to select different programmes contained in different kinds of data streams within a network even if such data streams have different formats, without any additional complicated procedures or any extra hardware.

These aspects may also be realised by, for example, a device used in a network comprising a plurality of sub networks, which may convey one or more data streams. The device may introduce issuing means to issue the commands so that the specific operation of the manually operable member is further able to cause a selection of a sub network, from which the programme is selected, from the plurality of sub networks. Otherwise these aspects may also be realised by, for example, a method selecting a programme composed of a plurality of data series from a plurality of programmes within a network comprising a plurality of sub networks, which may convey one or more data streams. The method may introduce a selecting step in which a sub network, from which the programme is selected, is further selected from the plurality of sub networks in response to the specific operation of the manually operable member.

According to these examples, users can to manually select a programme to be displayed from programmes conveyed in different sub networks within a network.

These aspects may also be realised by, for example, that said issuing means in the device issuing the commands so that the specific operation of the manually operable member causes a continuous selection of a data stream from data streams conveyed within the selected sub network.

According to this example, the specific operation of the same member are able to select a programme within the selected sub network. Accordingly, any kind of programme within any sub network can be selected in a very simple manner.

These aspects may also be realised by, for example, said manually operable means and said issuing means being in a remote control device which is used for controlling a certain remote electric apparatus.

These aspects may also be realised by, for example, the manual operable member being an increment or decrement key for incrementing or decrementing a programme number. Namely one or more operations on the increment key or the decrement key are interpreted as at least one specific manual operation. Accordingly, users can very easily manage such simple operations and it makes the man machine interface very simple.

As a further aspect of this invention, this invention introduces a computer programme product wherein the programme comprises instruction sequences matched to the implementation of a method described above.

As a further aspect of this invention, this invention introduces a data storage which can be read by a computer or a microprocessor storing instruction of a computer programme and makes it possible to implement the method described above.

All examples described above can be adapted to any invention regarding a device, an apparatus, a method, a computer programme product, and a data storage.

Other aspects and advantages of the invention will emerge from a reading of the following detailed description of particular embodiments, given by way of non-limiting examples. The description refers to the following drawings.

### BRIEF DESCRIPTION OF THE DRAWINGS

FIG. 1 depicts schematically a communication network according to one embodiment of the invention.

FIG. 2 depicts a connection device shown in FIG. 1.

FIG. 3a depicts a digital TV shown in FIG. 1.

FIG. 3b depicts a digital camcorder shown in FIG. 1.

FIG. 4a and 4b depicts the information conveyed by the network shown in FIG. 1.

FIG. 5 is a flow chart representing one example of successive steps of selecting programmes in the embodiment shown in FIG. 1.

FIG. 6 is a flow chart representing another example of successive steps of selecting programmes in the embodiment shown in FIG. 1.

FIG. 7 depicts a remote control device used in the embodiment shown in FIG. 1.

FIG. 8 is a flow chart representing successive steps executed by the CPU shown in FIG. 2 in accordance with another embodiment of the invention.

FIG. 9 is a flow chart representing successive steps of the selection method when the CPU acts as a talker host.

FIG. 10a shows an example of the isochronous channel request packet.

FIG. 10b shows an example of the isochronous channel acknowledge request packet.

### DETAILED DESCRIPTION OF PREFERRED EMBODIMENTS

To make it easy to implement this invention, some of embodiments or aspects of this invention are described below.

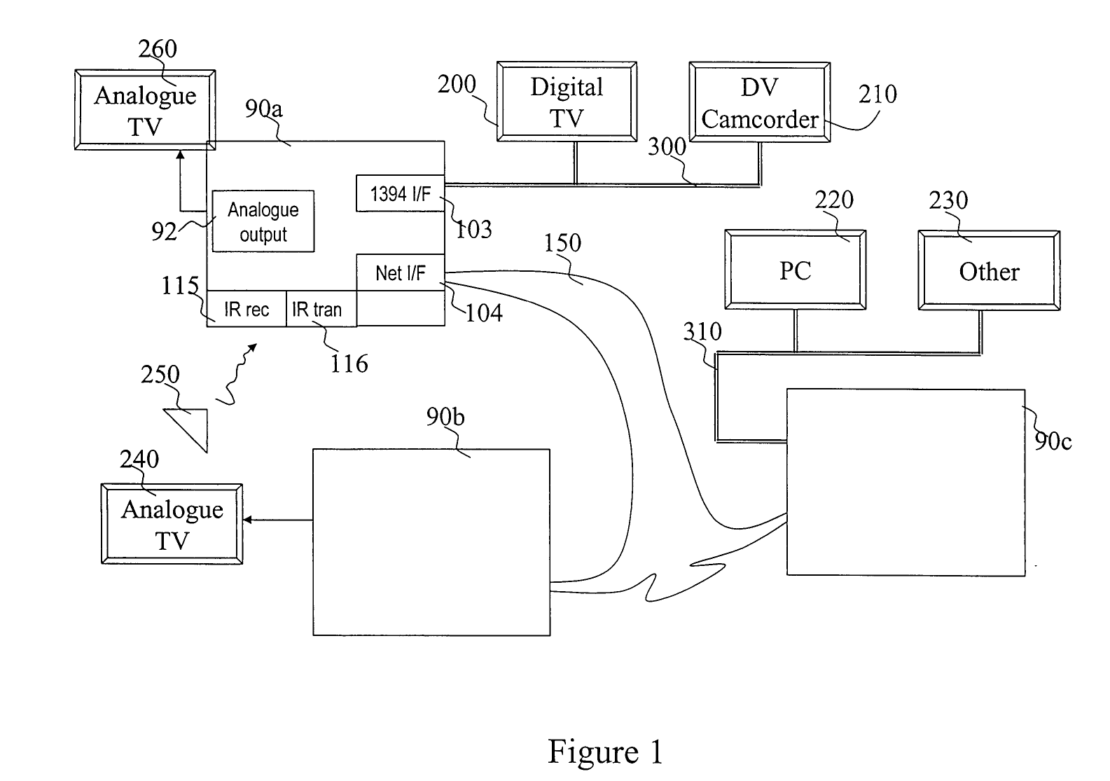

FIG. 1 depicts a communication network and more precisely an audio-visual system, which is presented here solely by way of example in order to illustrate the characteristics of communication networks according to this embodiment of the invention.

The communication network depicted connects together different hosts consisting here of several data processing apparatus such as, for example, printers, servers, personal computers (PC) 220, scanners, decoders, satellite tuners, analogue television receivers (analogue TV) 240 and 260, digital television receivers (digital TV) 200, digital DV camcorders 210, high-definition screens, and so on.

Some of the hosts process digital data functioning preferably according to IEEE-1394. This standard concerns serial communication buses having high performance, and conveying data in packets at speeds of between 100 and 200 Mbps, or even around 400 Mbps (1 Mbps=10⁶ bits per second).

It is often convenient to connect several hosts to the same bus. Advantageously, such a bus can convey not only the data, for example audio-visual data, processed by a host which is connected to it, but also the commands serving to make this host operate. These IEEE-1394 compliant serial buses are depicted as reference 300 and 310 in the FIG. 1. Each of them will constitute a sub network according to this invention.

In addition, the network according to the invention comprises a remote control device 250 for selecting a programme among streams conveyed by the network or sub networks. The signals emitted by a remote control can be conveyed by a wire or, as depicted in FIG. 1, by a non-cabled link (for example in the form of infrared or radio signals).

The communication network in question also includes a packet switching sub-network 150, which comprises communication nodes connected by bidirectional links (transmission lines). Thus the data transmitted by a first host can reach a second host by passing through the switching sub-network 150.The communication nodes referenced as 90a, 90b and 90c in FIG. 1 may be connected to both an IEEE-1394 sub network 300, 310 and to the packet switching sub network 150.

For reasons of simplicity, only the node 90a will be described, nodes 90b and 90c are functionally identical to node 90a.

The node 90a comprises mainly four different kinds of interfaces. A first one is denoted 103 and permits to the node to be connected to a IEEE-1394 sub network 300. A second one is denoted 104 and permits to the node 90a to be connected to the switching sub network 150. A third one is denoted 92 and permits to connect analogue devices such as an analogue TV 260 to be linked to the network. Final one is an infrared interface consists of an infrared receiver 115 and an infrared transmitter 116.

It is to be noted that the infrared red transmitter 116 is optional and can be included in the node 90a either if the remote control device can exchange bi-directional information or if the node 90a needs to forward infrared commands addressed either to analogue equipment connected to its analogue interface 92 or to infrared controllable equipment connected to IEEE1394 serial bus 300 attached to the node 90a.

The switching sub-network 150 is based on packet switching technology, including point-to-point flow control at link level, for instance as described in the IEEE-1355 standard. By scheduling source packets, it allows transmission of packets of arbitrary size containing asynchronous data or isochronous data, and in addition imposes no constraint on the transmission rate of the isochronous data. “Source routing” is use in order to guarantee overall packet transmission quality from a source node.

The routing of the packets concerns the way in which the data transmitted by the source node find their destination or destinations on the network. When a message, a programme or a stream is conveyed over the links in the network, it is normally distributed over several data packets. Within each packet, the message data are framed by control instructions forming the appendix of the packet and by identification data forming the header of the packet (or vice versa).

More precisely, the appendix of the packet normally contains a mark identifying the end of packet, except if it is the last packet in a message; namely, the appendix contains a mark identifying the end of the message or the programme. As for the packet header, this indicates notably the destination of said packet and the path that has to be taken by it through the network in order to reach its destination. This is why “Source routing” is spoken of.

Each node 90a, 90b, 90c in the switching network 150 always “knows” all these paths, which are determined from the topology of the network, and updated after each modification of this topology. In order to understand the way in which this set of paths is, automatically, formed and then broadcast to all the nodes in the network, reference can be made to the application FR-2778295 in the name of Canon.

Thus, when a user installs the data packet switching sub-network serving as an intermediary between various data processing apparatus, the switching sub network 150 fixes the topology of the communication network whilst avoiding the drawbacks related to the choice of this topology, and therefore avoiding consideration of the audio-visual requirements, the performances of the different data processing apparatus, their location, and so on.

In addition, in the switching network 150, the propagation times being less critical than on a serial bus, it is possible to increase the length of the cables independently of the propagation time, which advantageously makes it possible to move the communication serial buses 300, 310 away from each other. It is thus possible to connect the audio-visual apparatus installed in various rooms in a house.

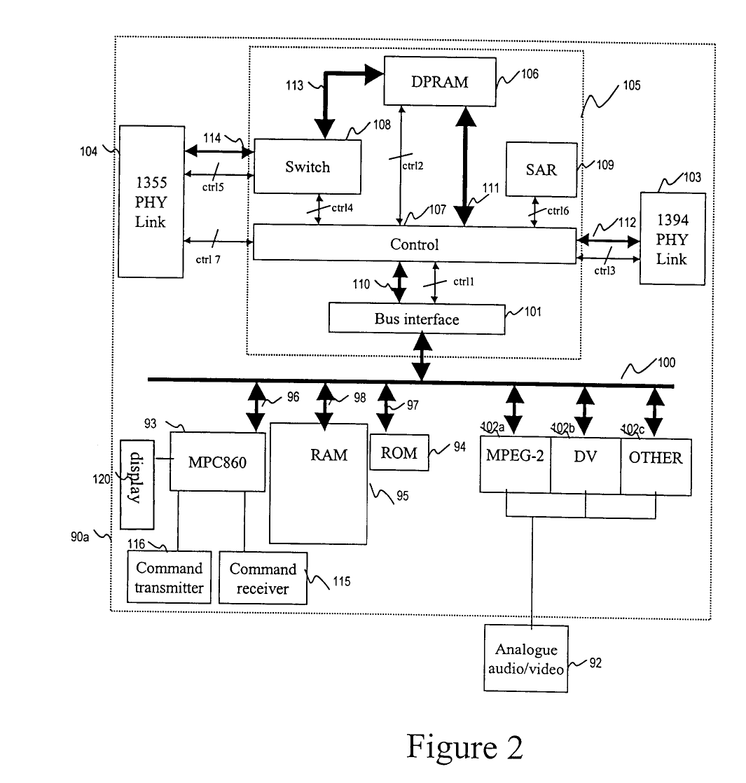

FIG. 2 depicts a schematic view of a connection device (node) 90a according to this embodiment of the invention intended to form part of a data packet switching node within an audio-visual system.

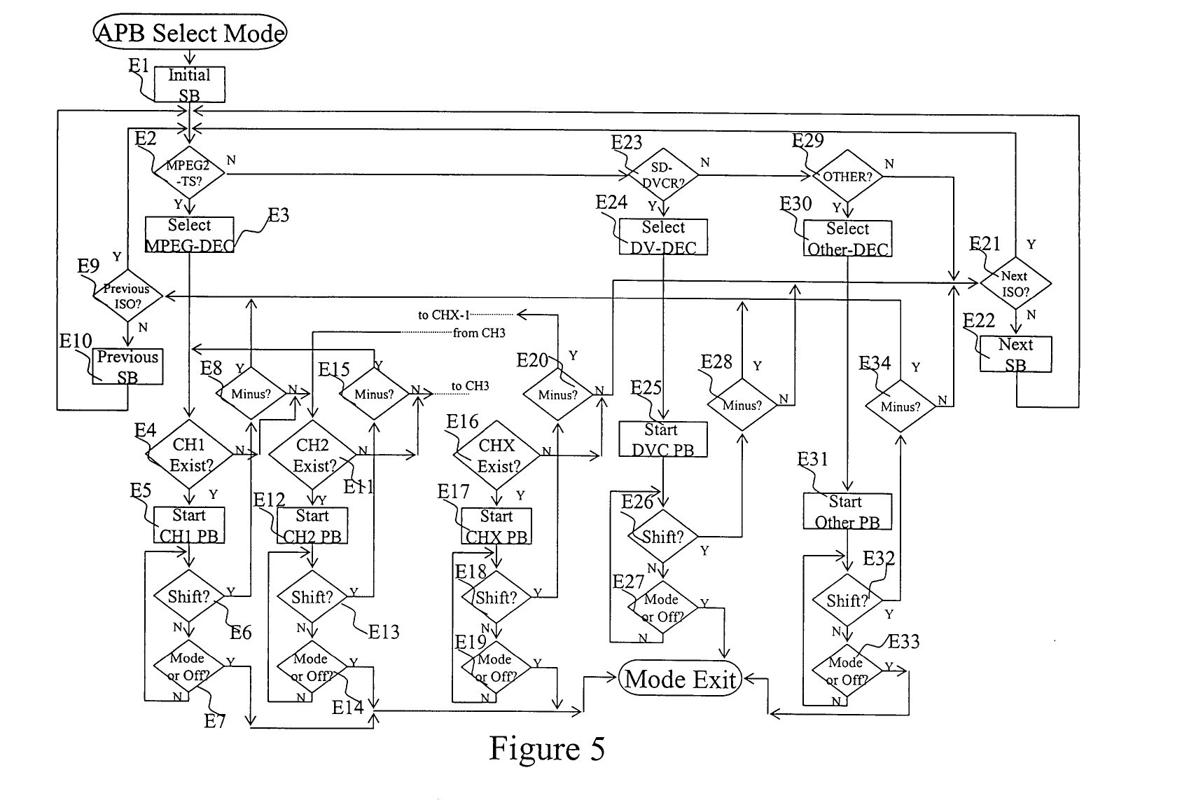

The device 90a has a permanent memory means 94 of the ROM type, which contains the software architecture of the device, and a temporary memory means 95 of the RAM type. The ROM memory 94 contains instructions corresponding to the flow chart of FIGS. 5, 6, 8 and 9, which will be described later.

It is, for example, possible to connect to connection device 90a, through an analogue audio/video interface 92, a device consisting of an analogue audio-visual data processing apparatus, such as an analogue television receiver (TV) 260. These analogue data are converted from digital data, in a conventional manner, by decoders 102a 102b or 102c.

According to the type of data stream to be decoded, one of decoders 102a, 102b and 102c decodes the selected data stream. For simplicity, the video processing, the analogue to digital conversion and the adaptation into PAL/NTSC or other format are not disclosed in detail in this application. A person skilled in the art can easily realise them.

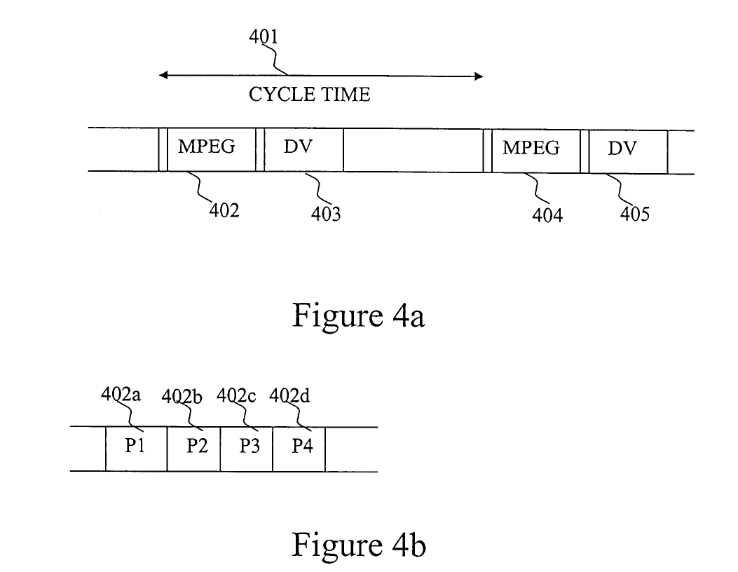

A decoder 102a is able to decode MPEG2 data streams extracted from a MPEG2-TS data transmission which will be explained in more detail with reference to FIG. 4, a decoder 102b is able to decode streams in accordance to DV format extracted from a SD-DVCR data transmission and a decoder 102c is able to decode data streams comprising as example still images or moving image (video) sequences compatible with the new standard motion JPEG2000. Briefly, motion JPEG 2000 format is related to the compression of sequence of image, each image being compressed according to JPEG2000 standard. The main features of motion JPEG2000 are related to the realisation of a file including all of these compressed images.

Therefore, the control block 107 comprises the audio-visual data flow processing capabilities in accordance with IEEE-1394 and IEC-61883, sections 1 to 5 (“Standard for a Consumer-Use Digital Interface”) and possible future standard extensions.

The unit 93 is a microprocessor able to execute the software architecture stored in the ROM 94. This microprocessor may for example be an MPC860 controller from Motorola. On the one hand, the unit 93 transmits or receives digital data by means of the bus 96. On the other hand, the unit 93 comprises input/output ports, of the Serial Communication Controller (SCC) type, which can be connected to the units 115 and 116 or a display 120. The display 120, which is not mandatory, can indicate information related to the stream being decoded, and the sub network wherein the stream comes from.

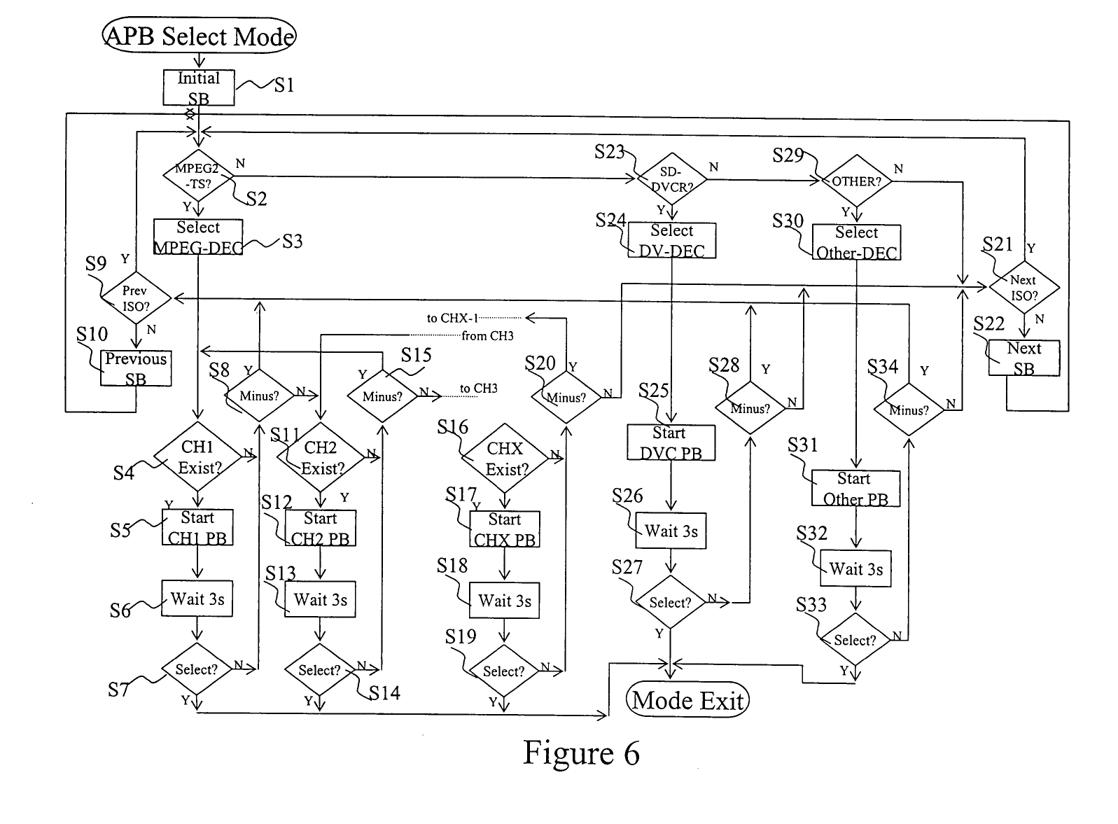

The unit 115 is a receiver able to receive operating commands intended for a certain host in the audio-visual system. The unit 115 may, for example, be able to receive control signals from a remote controller 250 (see FIG. 1) in the form of infrared radiation. The unit 93 in accordance with the flow charts described in FIGS. 5 and 6 interprets the command signals leaving the receiver 115 and entering the unit 93 by means of the SCC ports.

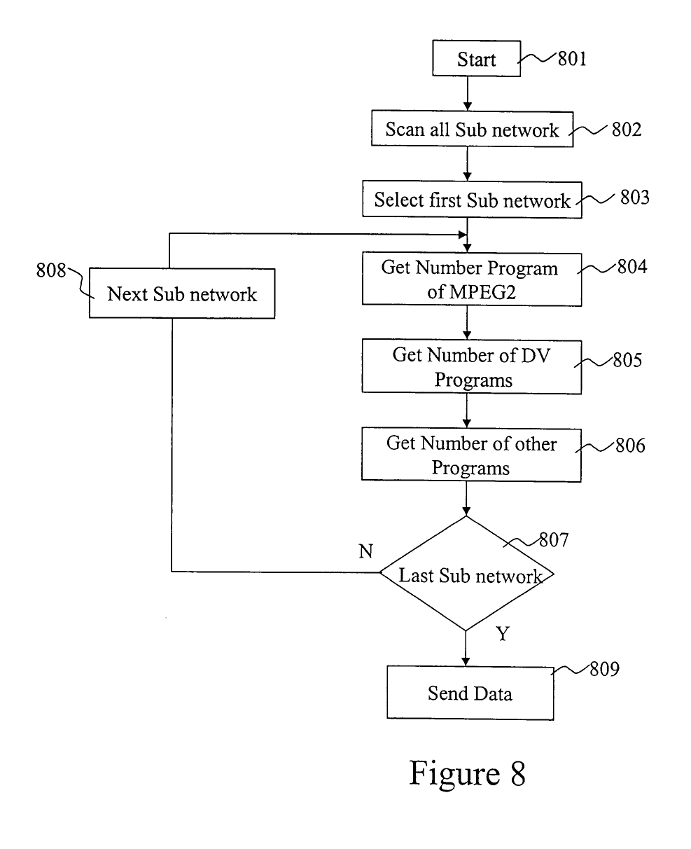

The unit 116, which is not mandatory, can also send command signals, according to a variant, when the remote control device is a bidirectional one and transfers information originated by the unit 93, in accordance with the selected data stream and/or with the selected sub network. The unit 116 can transmit data according to a flow chart shown in FIG. 8. It will be described later on. A display 120 can display information originated by the unit 93 in accordance with the selected data stream and/or with the selected sub network.

The microprocessor 93, the ROM 94 and the RAM 95 communicate by means of respective address and data buses denoted 96, 97 and 98, themselves connected to a main bus 100. The bus 100 can also connect together other elements, not depicted in the figure, which are provided with a bus interface and are able to implement, for example, data processing functions.

The bus 100 functions in particular as an “external bus” for the microprocessor 93. The specifications of this functioning can be found in the corresponding user guide (“MPC860 Power QUICC User's Manual”, chapter 11). The interface component 101 allows exchanges of data between different modules connected to the bus 100 in accordance with the specifications which have just been mentioned.

As depicted in FIG. 2, the node according to the invention also has two interfacing means 103 and 104.

The interfacing means 103 complies with IEEE Std. 1394a-2000, “Standard for a High Performance Serial Bus (Supplement)”. It has at least one external port to be connected to a 1394 serial communication bus. The interfacing means 103 is for example a set of 1394 PHY/LINK components consisting of a PHY TSB21LV03A component and a LINK TSB12LV01A component sold by the company Texas Instruments and 1394 connectors such as those sold by Molex, for example under the reference 53462.

The interfacing means 103 contains memories of the FIFO type (the initials of “First-in First-out”, that is to say memories in which the data are read in the order in which they were previously written), which are used during the transfer of data packets of the type in accordance with IEEE 1394.

It comprises two FIFO transmission memories known as “ATF” (the initials of the words “Asynchronous Transfer FIFO”), and “ITF” (the initials of the words “Isochronous Transfer FIFO”) and a FIFO reception memory known as “GRF” (the initials of “General Receive FIFO”). These FIFO memories are more broadly described in the documentation associated with the LINK TSB12LV01A component.

The interfacing means 103 has means of counting the number of pulses according to the clock signal generated by a control module 107, which will be described subsequently.

This clock signal is synchronised with the serial communication bus with which it is in related, by means of cycle start packets. The frequency of the clock signal generated by the control module 107 is 24.576 MHz ±100 ppm. This signal is represented by ctrl3 in FIG. 2.

The interfacing means 104 mentioned above is an interface component 1355 connected to the switching part (not shown) of the node of the audio-visual system of which this device 90a forms part, thus enabling the device 90a to communicate with the rest of the system.

The device 90a has means of controlling the data flow 105 which allows the transfer of data between the different interface components 101, 103 and 104. This controlling means 105 is produced in programmable logic, implemented by a component of the “FPGA” type (the initials of “Field Programmable Gate Array”), for example with the reference Virtex, sold by the company XILINX.

The means 105 uses notably a double-port storage unit 106 which makes it possible to store data intended for or coming from the 1355 switched network. The storage unit 106 can for example be produced in the form of a memory of the “DPRAM” type (the initials of “Dual Port Random Access Memory”) with 32bit access. It has a plurality of memory areas which are managed as individual areas of the “FIFO” type. These memory areas each have associated reading and writing pointers.

Since each memory area is managed like a memory of the FIFO type, its filling and emptying can be carried out at the same time, and independently. This makes it possible to desynchronise the data reading and writing operations carried out by a unit 108 for switching the data reading and writing operations carried out by a control unit 107 (these two units are described below).This is because the level of occupation of the memory area in question is managed in a circular manner and it is known at all times whether or not the data contained in a memory area have been read. When these data have been read it is then possible to write new data in their place. The double port storage unit constitutes in some way a queue for the packets and the storage function is performed independently according to the port by which the packets reach the storage unit.

In general terms, all the isochronous or asynchronous data coming from the switched network are stored in the storage unit 106.This storage unit 106 is temporary for the asynchronous data packets, (packets constituting a message transmitted in non-connected mode and for the connection protocol packets).On the other hand, the packets of isochronous data (packets of the “data stream” type, that is to say those transmitted in connected mode), are stored solely in this storage unit 106 before they are transmitted over the communication bus to which the device 90a is connected or to other nodes in the audio-visual system.

This is explained by the fact that the data of this type must be transferred as quickly as possible before being transmitted over the bus and must therefore be stored in memory in a storage means which is easily and rapidly accessible. In addition isochronous data targeted to the decoding means 102a, 102b or 102c are directly transmitted from storage means 106 over the bus interface 101 means under control of control means 107 without intermediate storage in RAM memory 95.Likewise, the packets of isochronous data issuing from the communication bus to which the device 90a is connected and which are intended for other nodes are stored solely in the storage unit 106 and not in the RAM 95, for the same reasons as those mentioned above. Similarly, those packets of isochronous data targeted to the decoding means 102a, 102b or 102c are directly transmitted from IEEE1394 interface 103 over the bus interface 101 means under control of control means 107 without intermediate storage in RAM memory 95.

As depicted in FIG. 2, the data flow control means 105 has several other elements, including a control unit 107 (already mentioned above) which fulfils a function of controlling the storage unit 106 and manage data flow exchange between interfaces 103, 104 and 101, a switching unit 108 (already mentioned above) in communication with the interfacing means 104, with the storage unit 106 and with the control unit 107, and a unit for sequencing the data packets 109 which is in relationship with the control unit 107.

The function of the control unit 107 is to multiplex the accesses in read or write mode to registers of other modules from the main bus denoted 100. It should also be noted that the control unit 107 communicates with the interfacing means 103 and 104 and with the bus interface component denoted 101. The control unit 107 is also in charge of data transport reception processing attached to isochronous packet when targeted to decoding means 102a, 102b or 102c in accordance respectively to SD-DVCR, MPEG2-TS data transmission standard and future extensions for instance for motion JPEG 2000 data transmission. The unit 107 also has control of the bus interface component 101 for the read and write operations on the main bus 100, including notably the transfer in “burst mode”.

To do this, the unit 107 exchanges data with the component 101 on an add-on bus 110 in accordance with the control signals denoted ctrl 1. The control unit 107 is also responsible for triggering interrupts on the main bus 100 according to particular communication events. The unit 107 is further responsible for controlling the storage unit 106 with regard to the read and write operations in FIFO mode by means of a data bus 111 and control signal bus ctrl 2. The control unit 107 and the interface means 103 manage the data transfer on a bus 112 conveying the control signals ctrl 3. Moreover, the control unit 107 controls the switching unit 108 by means of control signals ctrl 4 in order to transfer data from the switching unit to the storage unit 106 by means of a data bus 113 and vice versa. The switching unit 108 is connected to interface means 104 by means of a data bus 114 conveying control signals ctrl 5.

The data packet sequencing unit denoted SAR 109 (initials of “Segmentation And Reassembling”) informs the control unit 107 of the next data packet or packets to be transmitted by means of control signals ctrl 6. In addition, the sequencing unit 109 checks the reception of the data packets and manages the allocation and release of the memory areas in the storage unit 106.

The control signals ctrl7 exchanged between the interfacing means 104 and the control unit 107 comprise notably the clock signals regenerated from the reception of packets according to IEEE-1355 received by the interfacing means 104. A 49.152 MHz crystal (not shown) is connected both to the means 104 for transmitting IEEE-1355 packets and to the control unit 107 which manages a clock signal at 24.576 MHz ±100 ppm, to the benefit on the one hand of the unit 109 sequencing the IEEE-1355 packets and on the other hand the interfacing means 103, in order to time the transmission of the IEEE-1394 packets.

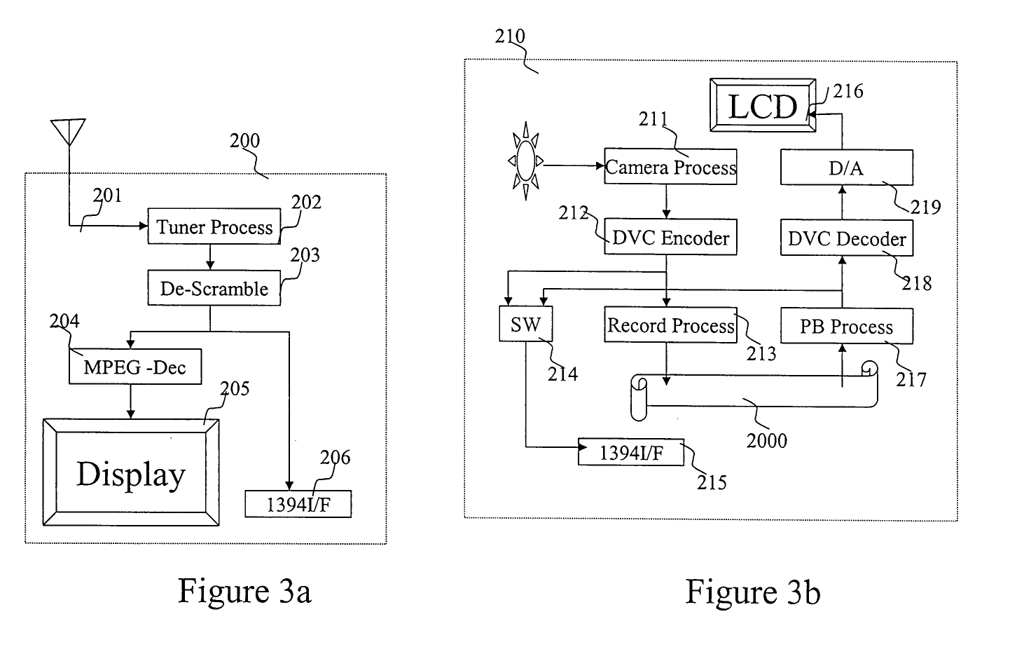

FIG. 3a shows a block diagram of the digital TV 200 shown in FIG. 1. As shown in this FIG. 3, digital television includes a tuner 202 connected to an antenna 201, a de-scrambler 203 and a MPEG2 decoder 204 which will decode the selected channel which is to be displayed on the display 205. An IEEE1394 interface 206, includes IEEE1394 interfacing circuits. Interface 206 transmits all the MPEG data, which have been de-scrambled, on an IEEE1394 bus.

FIG. 3b shows a block diagram of a digital camcorder 210 also shown in FIG. 1. The digital camcorder includes a camera process circuit 211 which transforms the optical image through an optical system into binary data, such binary data are encoded according to the DV standard by an encoding circuit (DVC encoder) 212. Such encoded data are processed by a recording process circuit 213 so as to be recorded on a memory medium 2000 which can be a tape or a disc. The digital camcorder 210 further includes, a play back process circuit 217, a decoding circuit (DV decoder) 218, a digital to analogue converter (D/A) 219, which permits the display of the recorded data using a liquid crystal display (LCD) 216.

The digital camcorder 210 further includes a switch 214, which enables the transfer through an IEEE1394 interface 215 of encoded data compliant with the DV format. Each of these features of digital camcorder 210 is well known to those of ordinary skill in the art; however, descriptions thereof are nevertheless provided herein for the sake of completeness.

FIG. 4a shows data conveyed by the communication bus network. According to IEEE 1394 standard, data are inserted into cycle times. A cycle time 401 is defined as a 125 microseconds period. Each cycle time comprises a cycle start packet, not shown here. In the example of FIG. 4a, the cycle time 401 comprises two different kinds of packets, a first one 402, which comprises MPEG2-TS packet, and a second one which comprises DV packets.

Packets 404 and 405 are the following packets in the next cycle time of the packets 402 and 403 respectively. MPEG2-TS packets and DV packets respectively represent data streams and are respectively composed of series of packets.

MPEG2-TS packets comprise several data series corresponding to several programmes. In the example of FIG. 4b, four different data series are contained in MPEG2-TS packet 402 and 404. Example 402a is a data series related to a first programme, 402b is a data series related to a second programme, data series 402c and 402d are related respectively to a third and fourth programme.

FIG. 5 is a flow diagram depicting the main successive steps of the algorithm used for selecting, with a command, a programme in the communication network. The network conveys different kinds of data streams, namely a first kind of data stream such as packets 402 and 404 of FIG. 4a, e.g. MPE2-TS (Transport Stream), comprising a plurality of different programmes (data series), and a second kind of data stream such as packets 403 and 405 of FIG. 4a, e.g. DV data stream, which comprises only a single programme. This algorithm is executed, in the connection device 90a by the microprocessor 93 on the basis of instructions supplied by the ROM 94. When this algorithm is executed, the host locating in this device 90a is called a listener host.

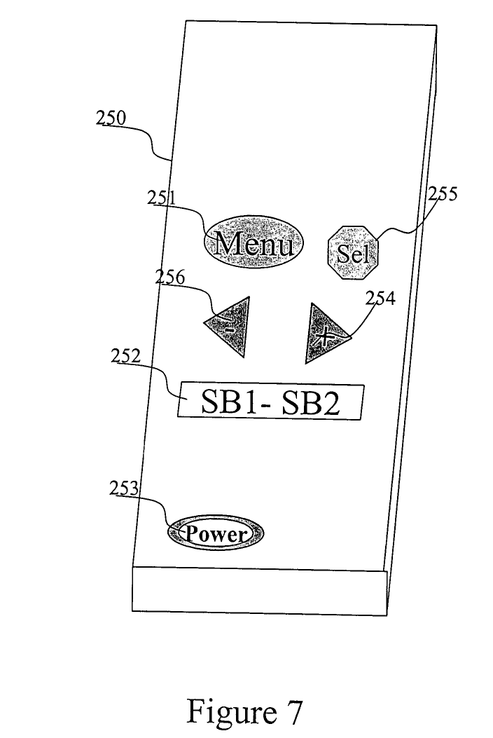

When the selection method is started by a command, which can be as example the reception of a menu command, described latter by using FIG. 7, by the device 90a and originated by a remote control device 250, through the infrared receiver 115, the CPU 93 moves to a step E1.

At the step E1, the CPU selects one of the ports of the 1394 physical link 103, namely one of the sub network is selected. In the example of FIG. 1, the 1394 bus 300 is selected. The host attached to the selected 1394 bus is called the talker host while the host running the algorithm is the listener host. When local 1394 bus is selected, the host becomes both talker and listener. The listener host sends an isochronous channel request command to the talker host, for instance selecting the talker host with the smaller IEEE1394 bus identifier. When an isochronous channel request command is received, the talker host selects an isochronous channel on its IEEE1394 bus, if any.

Either positive or negative acknowledge is sent back to the listener host. In case of positive acknowledge, the talker host establishes a communication pipe in the sub-network 150 to the listener host and filtered isochronous packet are sent to the listener host through the communication pipe.

At a step E2 the listener host checks if isochronous channel request acknowledge is positive and the isochronous channel includes a data stream representative of MPEG2-TS data and in case of positive judgement, the CPU moves to a step E3 after selecting MPEG2 decoder 102a.

The following step E4, consists of searching for a first programme among the programmes (data series) contained in the MPEG 2 transport stream. Then the CPU configures the control module to perform one programme filtering within the MPEG2-TS.

If such a first programme exists, the first programme, for example the programme P1 of FIG. 4b, is decoded by the decoder 102a, and is transmitted to the analogue TV 260 of FIG. 1. Such first programme is then displayed by the analogue TV 260. This display (playback) is achieved by a step E5. If there is no programme considered as a first programme among those contained in the MPEG2-TS, the CPU moves to a step E11 that will be described later.

Once the programme is displayed, in a step E6, the CPU judges whether or not there is a command coming from the remote control device 250 through the infrared receiver 115. It is to be noted that this command represents a manual operation on one of shift keys 254, 256 on the remote control device 250.

This remote control device 250 will be described in detail by using FIG. 7. If no command is received, the CPU judges in a step E7 whether or not the selection procedure is currently active. The selection procedure can be stopped, for example, by the end of a timer procedure or by an action on the menu key 251 which will be described later with reference to FIG. 7. If the selection procedure is stopped, the programme is stopped.

If the judgement of the step E7 is negative, the CPU goes to the step E6, the steps E6 and E7 make a loop until a shift signal caused by the key 254 or the key 256 is received or this selection procedure stops. Whilst the CPU is in the loop of the steps E6 and E7, the first programme is displayed. Alternatively, the step E7 can be removed and the step E6 made to loop back on itself if no shift signal is received.

If, in the step E6, the CPU detects a shift command coming from the remote control device 250 through the infrared receiver 115, the CPU moves to a step E8 and checks whether or not the shift signal is a command representative of a minus command. If it is a minus command, the CPU moves to a step E9. If it is not a minus command (i.e. it is a plus command) the CPU moves to a step E1.

At the step E9, the CPU of the listener host sends an isochronous channel request command to the current talker host. When the isochronous channel request command is received, the talker host selects the just-smaller isochronous channel (data stream) on its IEEE1394 bus, if any. Just-smaller isochronous channel means the one having the closest but smaller channel number than the one currently transmitted to the listener host.

Either positive or negative acknowledge is sent back to the listener host. In case of negative acknowledge, the talker host releases the communication pipe previously established in the sub-network.

In case of positive acknowledge, the just-smaller isochronous channel will be then transmitted through the communication pipe. In the step 9, if there is no more isochronous packet (data stream) on the sub network, the CPU of the listener host sends an isochronous channel request command to a new talker host and selects the talker host with the just-smaller IEEE1394 bus identifier than the previous talker host. When an isochronous channel request command is received, the newly selected talker host selects an isochronous channel on its IEEE1394 bus, if any.

Either a positive or a negative acknowledgement is sent back to the listener host. In case of positive acknowledgement, the talker host establishes a communication pipe in the switching sub-network 150 with the listener host and filtered isochronous packets are sent to the listener host through the communication pipe. In addition, positive acknowledgement indicates the data transmission format in use within the selected isochronous channel.

Once the step E10 is completed, the CPU moves to the step E2 already described.

If the judgements in the steps E8 or E4 are negative, the CPU judges if there is a second programme among the streams contained in the MPEG 2 transport stream. If, such a second channel exists, the second channel, for example the data series (programme) P2 of FIG. 4b, is decoded by the decoder 102a, and transmitted to the analogue TV 260 of FIG. 1. Such second programme is then displayed by the analogue TV 260.

Since, the steps E11 to E14 are similar to the steps E4 to E7, these steps are not described in detail.

At a step E15, the CPU judges whether or not the shift signal is a command representative of a minus command. If it is a minus command, the CPU moves back to the step E4 and previous first channel is displayed. If it is a plus command in the contrary, the CPU moves to a sequence that displays the next (third) channel (CH3).

The steps E16 to E20 are similar to the steps E11 to E15. These steps carry out the same procedures for a channel named X as the procedures made for the second channel. If there is a minus command detected in a step E20, the CPU moves to a sequence that displays the previous channel. If there is a plus command and X is possible total number of channels (programmes) within MPEG2-TS, it means that all programmes have been scanned and the CPU moves to a step E21. For example, if a user continuously operates the plus key 254 shown in FIG. 7, each programme P1, P2, P3 and P4 is displayed in response to each operation. If a user makes further continuous operation, the subject programme to be displayed moves to programme contained in another data stream, for instance the DV data stream.

At the step E21, the CPU of the listener host sends an isochronous channel request command to the current talker host. When the isochronous channel request command is received, the talker host selects the just-bigger isochronous channel (data stream) on its IEEE1394 bus, if any. Just-bigger isochronous channel is the closest isochronous channel having a bigger channel number than the one currently transmitted to the listener host.

Either positive or negative acknowledgement is sent back to the listener host. In case of negative acknowledgement, the talker host releases the communication pipe previously established in the sub-network. In case of positive acknowledgement, the just-bigger isochronous channel will be then transmitted through the communication pipe. If there are no more isochronous packets (data streams) on the sub network, the CPU of the listener host sends an isochronous channel request command to a new talker host, selecting the talker host with the just-bigger IEEE1394 bus (sub network) identifier than the previous talker host.

When an isochronous channel request command is received, the new talker host scans and, if any, selects an isochronous channel other than the one previously used, on its IEEE1394 bus. If there is any isochronous channel in the new 1394 bus, a positive acknowledgement is sent back to the listener host. In case of positive acknowledgement, the talker host establishes a communication pipe in the switching sub-network 150 to the listener host and filtered isochronous packets are sent to the listener host through the communication pipe. In addition, positive acknowledgement indicates the data transmission format in use within the selected isochronous channel and the CPU moves to the step E2.

It can be noted that the same command, namely plus command or minus command, is used to select either a programme (data series) from one isochronous packet, a data stream (isochronous packet) among data streams, or a sub network (IEEE1394 bus) among the sub networks connected to the switching network. Accordingly, in the algorithm described by using FIG. 5, at least one specific manual operation claimed is to be understood as one or more manual operation of the plus or minus key.

In the step E2, it is determined whether the isochronous channel request acknowledgement is both positive and representative of MPEG2-TS data transmission. In a step E23, the CPU checks in a similar way to the step E2 if the isochronous channel request acknowledgement is both positive and representative of SD-DVCR data transmission. Such packets are provided by digital camcorders, for example.

If there is any DV data stream, the CPU moves to a step E24, in which the decoder 102b is selected, and starts transferring decoded packets through the analogue audio interface 92 to the analogue TV in a step E25. Once the decoded packets are displayed, in a step E26, the CPU checks whether or not there is a command coming from the remote control device 250 through the infrared receiver 115. It is to be noted that this command represents an action on a shift key on the remote control device, such command is the same as the command received in the steps E6, E13 and E18.

If no command is received, the CPU checks in a step E27 if the scanning procedure is currently active, the scanning procedure can be stopped in a similar manner as described with reference to the step E7. If the scanning procedure is stopped, the CPU stops the programme. If the step E27 is negative, the CPU goes to the step E26, the steps E26 and E27 make a loop until a shift signal is received or this selection procedure stops.

If, in the step E26, the CPU detects a shift command coming from the remote control device 250 through the infrared receiver 115, the CPU moves to a step E28 and checks whether or not the shift signal is a command representative of a minus command. If it is a minus command, the CPU moves to the step E9, and if it is not a minus command (i.e. it is a plus command) the CPU moves to the step E21. In the step E9, the CPU scans for a just-smaller isochronous channel on the current IEEE1394 serial bus. In the step E21, the CPU scans for a just-bigger isochronous channel on the current IEEE1394 serial bus. These steps have already been described and they will not be explained again.

If isochronous packets (data stream) are not compliant with SD-DVCR data transmission in the step E23, the CPU moves to the step E29. In that step, the CPU checks if it is representative of a format other than DV or MPEG2. If packets can be decoded by the decoder 102c, the CPU moves to the step E30. If there are no further packets, or no further packet which can be decoded by the decoder 102c of FIG. 2, the CPU moves to the step E21 already described.

In the step E31, the CPU starts transferring decoded packets through the analogue audio interface 92 to an analogue TV. Once the decoded packets are displayed, in the step E32, the CPU checks whether or not there is a command coming from the remote control device 250 through the infrared receiver 115. It is to be noted that this command represents an action on a shift key on the remote control device 250 and that command is the same as the command received in the steps E6, E13, E18 and E26. If no command is received, the CPU checks in the step E33 if the scanning procedure is currently active. If the scanning procedure is stopped, the programme is stopped.

If the judgement in the step E33 is negative, the CPU goes to the step E32 and the steps E32 and E33 make a loop until the shift signal is received or the selection procedure stops. If in the step E32, the CPU detects a shift command coming from the remote control device 250 through the infrared receiver 115, the CPU moves to the step E34 and checks whether the shift signal is a command representative of a minus command or not. If it is a minus command, the CPU moves to the step E9, and if it is not a minus command (i.e. it is a plus command) the CPU moves to the step E21.

FIG. 6 is a flow diagram depicting the main successive steps of the algorithm used for selecting, with a command, a programme in the communication network. The network conveying different kinds of data streams as packets, namely MPEG-TS data stream and DV data stream as described before by using FIG. 4a. This algorithm is executed in the connection device 90a by the microprocessor 93 on the basis of instructions supplied by the ROM 94.

This algorithm is similar to the one described in FIG. 5, most of the steps are similar. Steps S1 to S5 of FIG. 6 are similar to the steps E1 to E5 of FIG. 5. Steps S8 to S12 of FIG. 6 are similar to the steps E8 to E11 of FIG. 5. Steps S15 to S17 of FIG. 6 are similar to the steps E15 to E17 of FIG. 5. Steps S20 to S25 of FIG. 6 are similar to the steps E20 to E25 of FIG. 5. Steps S28 to S31 of FIG. 6 are similar to the steps E28 to E31 of FIG. 5. Step S34 of FIG. 6 is similar to the step E34 of FIG. 5. These steps will not be described again.

The main difference between the two algorithms is in the steps S6 to S7, steps S13 to S14, steps S18 to S19, steps S26 to S27 and steps S32 to S33.

According to the algorithm shown in FIG. 6, once each programme is displayed by the analogue TV 260 in a step S5, the CPU in a step S6 waits a predefined time, for example 3 seconds, and checks in a step S7 whether or not a selection command has been received through the infrared receiver 115. In the case of no selection command, the CPU automatically goes to a step S8 that is identical to the step E8 previously described. The same procedures are taken in steps S13 to S14, steps S18 to S19, steps S26 to S27 and steps S32 to S33. Though this automatic change of a programme can normally be termed scanning, this scanning shall be understood as selecting a programme to be displayed anyway.

The selection command is made by an operation on the key denoted 255 in FIG. 7. During the display of each programme, a user can operate the key 255 so as to issue the selection command. If a selection command has been received, it means that a desirable programme has been selected. When that desirable programme is displayed, the scanning process is stopped. As a result, once a user generates a command for scanning and displaying of all programmes, which exist within the network, such scanning and displaying will continue until the selection command is detected by the CPU.

Accordingly, in the algorithm described with reference to FIG. 6, at least one specific manual operation claimed is to be understood as a manual operation made to the menu key.

As described above, algorithms represented by FIGS. 5 and 6 disclose that the same command or the same manual operation can be used either for selecting different programmes (data series) in one data stream (packet), for selecting different data streams of different packets within one sub network, or for selecting different sub networks.

FIG. 7 depicts a remote control device used in this embodiment. The remote control device 250 consists of an IR transmitter not shown in the FIG. 7. This device 250 is mainly constituted of 2 keys, namely a plus “+” key 254 and a minus “−” key 256 in FIG. 7. These two keys 254 and 256 are collectively called as shift keys.

An operation on the key 254 or the key 256 generates the infrared command, which is detected, as a shift operation, by the CPU 93 of the node 90a in the steps E6, E13, E18, E27 and E32 of the algorithm of FIG. 5. The infrared command caused by an operation on the key 254 or the key 256 is also detected by the CPU 93 of the node 90a in the steps E8, E15, E20, E28 and E34 of the algorithm of FIG. 5. Accordingly each of these keys 254 and 256 is then able to select either different kinds of programmes, data streams or different sub networks.

According to another embodiment described with reference to FIG. 6, an operation on a key 255 generates the infrared command which is detected by the CPU 93 of the node 90a in steps S7, S14, S19, S27 and S33 of the algorithm of FIG. 6. An operation on the key 254 or the key 256 also generates the infrared command which is detected by the CPU 93 of the node 90a in steps S8, S15, S20, S28 and S34 of the algorithm of FIG. 6.

As can be easily understood, the embodiment described above introduce the function that a single manually operable key allows scanning or selecting of either different kinds of programmes (data series), data streams (series of packets) or different sub networks.

An operation on a key 251, called “Menu”, generates an infrared command to be received by the CPU 93. Receiving the infrared command (Menu command) caused by the key 251, CPU93 starts the algorithms of FIG. 5 or FIG. 6. This Menu command can also be used for stopping the algorithm described in FIG. 5 or FIG. 6.

The remote control device 250 can also, in a variant, have a display on which information associated with the current selected programme, sub network or data stream are shown. Such display can be particularly interesting when the node 90a of FIG. 2 is not equipped with the display 120.

According to another embodiment, the remote control device 250 includes a processor, a read only memory (ROM), a random access memory (RAM), an infrared receiver and is able to embed algorithms of FIG. 5 or FIG. 6.

For the algorithm disclosed in FIG. 5, the selection method is started by an operation on the menu key 251 and a CPU located in the remote control device (hereinafter the remote CPU) moves to the step E1.

In the step E1, the remote control device 250 receives information from the node 90a in accordance with the algorithm of FIG. 8, which will be described later. Information received from the infrared receiver is stored in the RAM of the remote control device 250. Such information comprises the list of sub networks and their numbering, the list of data streams and their numbering, i.e. the number of MPEG2 transport packets on each sub network, the number of DV packets on each sub network and the number of other packets, which can be decoded by the decoder 102c of FIG. 2. The first sub network is then selected.

In the step E2, the remote CPU determines by reading the RAM whether or not there is an MPEG transport packet on the selected sub network. If there are any MPEG2 transport packets, the remote CPU moves to the step E3 and sends a command signal to the node 90a in order to select the MPEG2 decoder 102a.

In the step E4, made by the remote CPU, the remote CPU searches to determine whether a first programme contained in the MPEG2 transport stream exists. If such a channel exists, as example the data series (programme) P1 of FIG. 4b, it is decoded by the decoder 102a, and transmitted to the analogue TV 260 of FIG. 1. That programme is then displayed by the analogue TV 260.This display is achieved by the step E5.

If there is no programme considered as a first programme (data series) within the MPEG2 transport stream, the remote CPU moves to the step E11 that will be described later. Once the programme is displayed, in the step E6, the remote CPU checks if a plus key 254 or a minus key 256 is being operated. If not, the CPU checks in the step E7 if the scanning procedure is currently active, it can be stopped for example by an operation of the Menu key 251 or at the end of a timer procedure. If the scanning procedure is stopped the programme is stopped.

If in the step E6, the remote CPU detects an operation of a plus key 254 or minus key 256, the remote CPU moves to the step E8 and checks whether the shift signal was caused by a minus key 256 or a plus key 254. If it is a minus command, the remote CPU moves to the step E9, and if it is a plus command, the remote CPU moves to the step E11.

In the step E9, the remote CPU checks by reading information in RAM memory if there are other isochronous packets (data streams). If there is another data stream, the remote CPU moves to the step E2 already described. If there are no more isochronous packets (data streams) on the sub network, the remote CPU generates a command to the node 90a in order to make the selection of the previous sub network in the step E10. Once the step E10 is completed, the remote CPU moves to the step E2 already described.

If the judgements made in the step E8 or the step E4 are negative, the remote CPU judges by reading information in its RAM if there is a second programme within the data stream, namely the MPEG 2 transport stream. If, such a programme exists, the remote control device 250 sends a command in order to decode the data stream using the decoder 102a of the node 90a, and to transmit the decoded data stream to the analogue TV 260 of FIG. 1. That programme is then displayed by the analogue TV 260.

The steps E11 to E20 are similar to the previously described steps, they will not be described in detail. In the step E21, the remote control CPU judges by reading the RAM if there are other isochronous packets (data streams). If there is another data stream, the remote CPU moves to the step E2 already described.

If there are no more isochronous packets (data streams) on the current sub network, and more precisely no more programmes on the current sub network, the remote CPU generates a command in order to make the CPU 93 of the node 90a select, via the control unit 107 and the IEEE 1394 interface unit 103, the next sub network in the step E22. Once the selection has been made, the remote CPU again moves to the step E2.

In this embodiment, it can be also noted that the same operation on a key 254 or a key 256 is used to select either a programme from isochronous packets (each data stream), a data stream among several data stream within one sub network, or a sub network among the sub networks of the network.

In the step E2 it is judged by reading information in the RAM within the remote control device whether there are any other MPEG2 transport stream. If there are no other MPEG2 transport streams than the one previously scanned, or no MPEG2 transport stream at all, the remote CPU moves to the step E23. In the step E23, the remote CPU checks in a similar way as the step E2 whether there are any isochronous packets (data streams) conforming to the DV format packets (DV data stream). Such packets are provided by digital camcorders for example.

If there are any DV data streams, the remote CPU moves to the step E24, in which a command signal is generated in order to make the selection in the node 90a of the decoder 102b and to start transferring decoded packets through the analogue audio interface 92 to an analogue TV in the step E25. In short, one programme contained in the DV data stream is now reproduced and displayed.

Once the decoded programme is displayed, in the step E26, the remote CPU checks if there is an operation of a shift key. If no operation is detected, the remote CPU checks in the step E27 whether the scanning procedure is currently active or not in a similar way to the step E7.

If in the step E26, the remote CPU detects an operation of a shift key, the remote CPU moves to the step E28 and judges whether the shift key is a minus key or a plus key. If the operated key it is a minus key, the remote CPU moves to the step E9, and if the operated key is a plus key, the remote CPU moves to the step E21.

If it is judged that there is no data stream conforming to DV format in the step E23, The remote CPU moves to the step E29. In the step E29, the remote CPU checks if they are data streams other than DV data stream or MPEG2 transport streams by checking the RAM in the remote control device. If there is any data stream, which can be decoded by the decoder 102c, the remote CPU moves to the step E30. If they are no other data streams, which can be decoded by the decoder 102c of FIG. 2, the remote CPU moves to the step E21 already described.

In the step E31, the remote CPU starts to transfer decoded packets through the analogue audio interface 92 to an analogue TV 260. The steps E32 to E33, which are similar to the steps E6 to E7, will not be described here.

So, in this embodiment, the same command or the same operation, more precisely the detection of the same action on the same key, is able to select a programme from the first kind of data stream, within the sub network, for example from the MPEG2 transport stream, and is able to select a programme from the second kind of data stream, for example, DV data stream or other format of data stream.

It is to be noted that the remote control device can also implement the scanning method described in reference with FIG. 6 in a similar way as the one described above.

FIG. 8 discloses the main steps of the algorithm made by the node 90a, in the case of a remote control device 250 having an infrared transmitter and receiver, a CPU, a RAM and a ROM. The algorithm mainly picks up all the necessary information about the network in order to transfer them to the remote control device 250, which implements this embodiment.

In response to the reception of a command originated by the remote control device 250, the CPU 93 starts the algorithm. The CPU 93 checks, by checking the RAM contained within the node 90a, the number of sub networks existing within the whole network. Such information being obtained by a classical way of discovering topology, such as that disclosed in the French patent application FR-2778295 already mentioned.

After obtaining such information, the CPU 93 moves to a step 803 and select the first sub network within the group of sub networks in the whole network. The CPU 93 obtains the number of programmes contained in the MPEG2 transport stream in a step 804. The CPU 93 also obtains the number of DV programmes, which is the same as the number of DV data streams, in a step 805. The CPU 93 further obtains the number of other programmes, which can be decoded by the decoder 102c of the device 90a, in a step 806.

Once such information has been obtained, the CPU 93 checks whether there are other sub networks in a step 807. If there are other sub networks, the CPU 93 generates control signals on the switching network 150 in order to make other IEEE1394 sub networks like the bus 310 shown in FIG. 1 communicational with the node 90a. The packets available on the bus 310 are then transferred through the switching network 150 to the node 90a. The CPU 93 moves to a step 808 and goes to the step 804 and performs the same checks as the ones already described on the steps 804 to 806 on the second sub network. That loop composed of the steps 804, 805, 806, 807, and 808 is executed until all sub networks have been checked.

Once all such information is picked up, the CPU 93 sends that information to the remote control device 250 through the infrared transmitter 116 in a step 809.

Of course, the method described with reference to FIG. 8 is also implemented for the scanning method described in reference with FIG. 6.

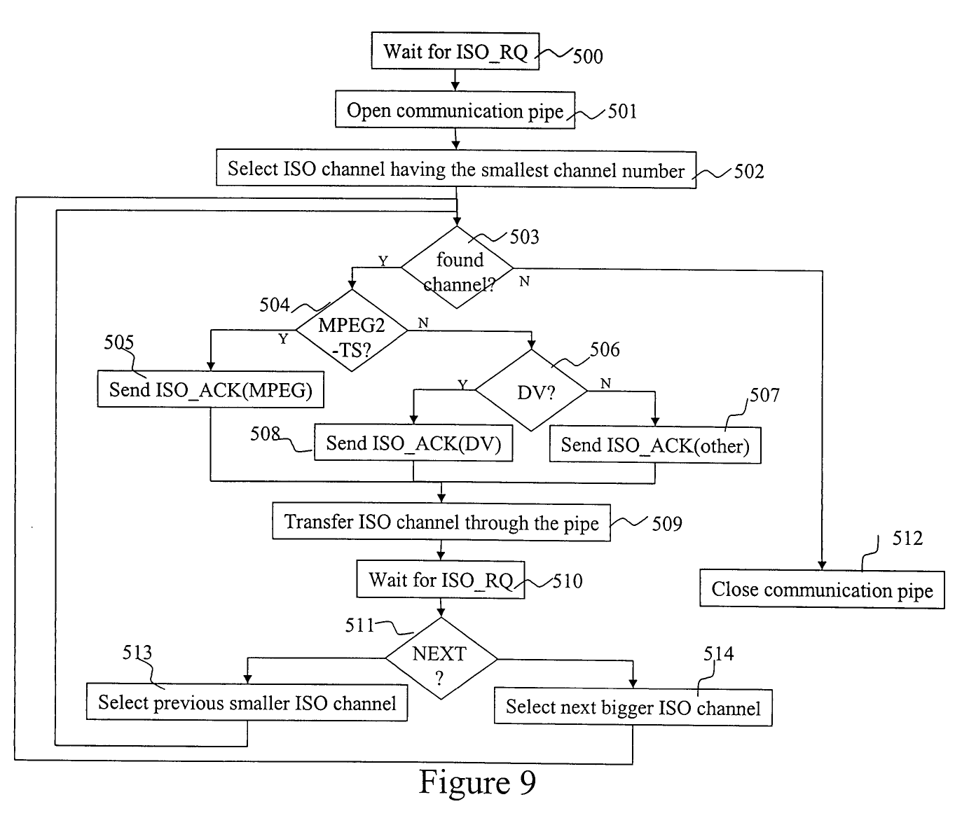

FIG. 9 is a flow chart depicting the main successive steps of the algorithm used for selecting an isochronous channel to be transmitted through switching sub-network 150 to the listener host. This algorithm is executed, in the connection device 90a, by the microprocessor 93 on the basis of instructions supplied by the ROM 94. When this algorithm is executed, the host is called a talker host.

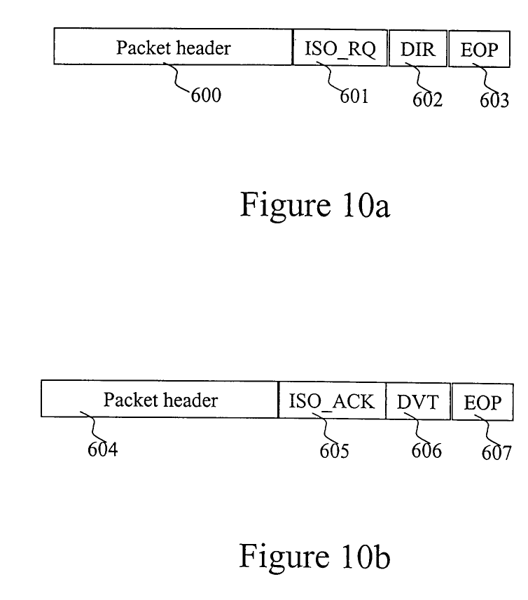

In a step 500, the CPU 93 in the talker host (the talker CPU) waits for the reception of an isochroous channel request command (packet) to be received from the interface means 104 (a switch interface). An example of the isochronous channel request packet is shown in FIG. 10a as a packet which can be sent as an asynchronous packet in the IEEE1394 interface. In a step 501, the talker CPU established a communication pipe “stream mode” between the IEEE1394 interface 103 and the switch interface 104 so that the isochronous packets directly reach the switch interface 104 of the listener host through DPRAM 106. The isochronous packets are directly supplied to the decoding unit 102a, 102b or 102c of the listener host through DPRAM 106 of the listener host.

In a step 502, the talker CPU controls its IEEE1394 interface 103 to capture an available isochronous channel (data stream) having the smallest channel number. In a step 503, it is judged whether an isochronous channel having the designated channel number exists or not. At first, the smallest channel number is designated. Therefore, if no isochronous channel exists whilst the smallest channel number is designated, it means there exists no isochronous channel. If it is judged, in the step 503, that no channel exists or no more channels exist with the designated channel number, the talker CPU closes the communication pipe and a negative acknowledge is sent to the listener host in a step 512.

If any isochronous channel (data stream) is found, the talker CPU checks the kind of data stream of the found isochronous channel through the control unit 107 in steps 504 and 506. If MPEG2-TS data stream is found in the step 504, the talker CPU moves to a step 505 and an isochronous channel acknowledge packet indicating MPEG2-TS is sent to the listener host. If MPEG2-TS data stream is not found, the talker CPU moves to a step 506. An example of the isochronous channel acknowledge packet is shown in FIG. 10b as a packet which can be sent as an asynchronous packet in the IEEE1394 interface.

In a step 506, if the DV (SD-DVTR) data stream is found, the talker CPU moves to a step 508 and an isochronous channel acknowledge packet indicating DV data stream is sent to the listener host. On the other hand, if a DV data stream is not found, the talker CPU moves to a step 507 and an isochronous channel acknowledge packet indicating the other data stream is sent to the listeners host.

After either step 505, 507 or 508, the found isochronous channel is transferred through the communication pipe in a step 509. In a step 510 the talker CPU waits for a next reception of an isochronous channel request command. After receiving such a next command, the talker CPU checks whether a bigger or a smaller channel number is requested in a step 511.

If the smaller channel number is requested, the talker CPU aims to select the isochronous channel having the next smaller channel number in a step 513. If the current channel already has the smallest channel number, it is judged no more channels exist in the step 503 and the talker CPU moves to the step 512. If the bigger channel number is requested, the talker CPU aims to select the isochronous channel having the next bigger isochronous channel number in a step 514. In the step 514, If the current channel already has the biggest channel number, it is judged no more channels exist in the step 503 and the talker CPU moves to the step 512. The process in the step 512 has been already described above.

As described by using a couple of examples, the embodiments and it variants cause significant advantages as follows.

Even if several programmes representing a video (moving image) exist in different types of formats, such as a single data stream or one of data series within one data stream when the user selects a desired programme, the selection is the same as when there are many programmes having the common data format. Therefore, the user can select a desired programme very naturally without being conscious of such different formats or conditions. Especially, since the user can only make manual operations on the same key (a manually operable member), it is very simple to select a subject programmes to be displayed amongst various different types of programmes.

Further, in accordance with the above embodiments, even in the case that several programmes representing a video (moving image) are available in the different sub networks of the whole network, the user is still able to select a desired programme without being conscious of such different sub networks by repeating manual operation on the same key.

In addition to this, in accordance with the above-described embodiments, programmes within the same data stream, such as a MPEG transport stream, are continuously selected with continuous manual operations on the same key amongst programmes in different data streams.

This specification describes only a limited number of embodiments and variants in order to easily understand the invention itself, however, it shall be understood that any variant can be made within the scope of claims.

What is claimed is:

1. A device for selecting a programme from a plurality of programmes, each programme being composed of a plurality of data series, the device being used with a network which conveys a plurality of different data streams, each data stream conveying one or more programmes, the device comprising:
a plurality of manually operable members, each allowing at least one manual operation; and
a command generator to issue commands able to select a programme from the plurality of programmes within the network based on the operation of one or more manually operable members amongst the plurality of manually operable members;
characterised in that said command generator is arranged to issue the commands so that a particular manual operation of said one or more manually operable members is able to cause, without other manual operations of the plurality of manually operable members, a selection of the programme from the one or more programmes within one data stream and a selection of the data stream, from which the programme is selected, from the plurality of different data streams.

2. A device according to claim 1, characterised in that the network comprises a plurality of sub networks, each network conveying one or more data streams and said command generator issues the commands so that the particular manual operation of said one or more manually operable members is further able to cause, without other manual operations of the plurality of manually operable members, a selection of a sub network, from which the programme is selected, from the plurality of sub networks.

3. A device according to claim 2, characterised in that said command generator issues the commands so that the particular manual operation of said one or more manually operable members continuously causes a selection of a data stream from data streams conveyed within the selected sub network.

4. A device according to claim 1, characterised in that said one or more manually operable members and said command generator are in a remote control device which is used for controlling an apparatus remote from the remote control device.

5. A device according to claim 1, characterised in that said one or more manually operable members include an increment and/or a decrement key for incrementing and/or decrementing a programme number.

6. A device according to claim 1, further comprising means for obtaining information regarding the network and information regarding types and contents of the programmes.

7. An apparatus for selecting a programme from a plurality of programmes, each programme being composed of a plurality of data series, the apparatus being connected to a network which conveys a plurality of different data streams, each data stream conveying one or more programmes, the apparatus comprising:
a receiver arranged to receive commands based on manual operations of a plurality of manually operable members each of which allows at least one manual operation; and
a control circuit arranged to select a programme from the plurality of programmes within the network based on the received commands;
characterised in that said control circuit selects the programme from the one or more programmes within one data stream and further selects the data stream, from which the programme is selected, from the plurality of different data streams in response to a specific manual operation of one or more manually operable members amongst the plurality of manually operable members without other manual operations of the plurality of manually operable members.

8. An apparatus according to claim 7, characterised in that said control circuit continuously selects the programme from the programmes conveyed by the selected data stream in response to the specific manual operation of said one or more manually operable members.

9. An apparatus according to claim 7, characterised in that the network comprises a plurality of sub networks, each network conveying one or more data streams and said control circuit selects a sub network, from which the programme is selected, from the plurality of sub networks in response to the specific manual operation of said one or more manually operable members without other manual operations of the plurality of manually operable members.

10. An apparatus according to claim 9, characterised in that said control circuit continuously selects a data stream from the data streams within the selected sub network in response to the specific manual operation of said one or more manually operable members.

11. An apparatus according to claim 7, characterised in that said one or more manually operable members are located in a remote control device which is used for controlling the apparatus.

12. An apparatus according to claim 11, characterised in that said one or more manually operable members include an increment and/or a decrement key for incrementing and/or decrementing a programme number.

13. An apparatus according to claim 7, further comprising means for obtaining information regarding the network and information regarding types and contents of programmes in the network, and wherein said control circuit selects the programme in accordance with the information obtained by said obtaining means.

14. An apparatus according to claim 13, further comprising means for transferring at least a part of the information obtained by said obtaining means to the remote control device.

15. An apparatus according to claim 7, further comprising a decoder for decoding different programmes encoded by different compression methods.

16. A method of selecting a programme from a plurality of programmes within a communication network, each programme being composed of a plurality of data series, wherein the network conveys a plurality of different data streams, each data stream conveying one or more programmes, the method comprising the steps of:
issuing commands based on manual operations of a plurality of manually operable members, each allowing at least one manual operation; and
selecting a programme from the plurality of programmes within the network based on the issued commands,
characterised in that the programme is selected in said selecting step from the one or more programmes within one data stream and the data stream, from which the programme is selected, is selected from the plurality of different data streams in said selecting step, in response to a specific manual operation of one or more manually operable members amongst the plurality of manually operable members without other manual operations of the plurality of manually operable members.

17. A method according to claim 16, characterised in that the programme is continuously selected from the programmes within the selected data streams in response to the specific manual operation of said one or more manually operable members in said selecting step.

18. A method according to claim 16, characterised in that the network comprises a plurality of sub networks, each network conveying one or more data streams, wherein a sub network, from which the programme is selected, is further selected from the plurality of sub networks in response to the specific operation of said one or more manually operable members without other manual operations of the plurality of said manually operable members in said selecting step.

19. A method according to claim 18, characterised in that a data stream within the selected sub network is continuously selected in response to the specific operation of said one or more manually operable members in said selecting step.

20. A method according to claim 16, further comprising a step of obtaining information regarding the network and information regarding types and contents of programmes in the network, and wherein the programme is selected in said selecting step in accordance with the information obtained in said obtaining step.

21. A computer programme product wherein the computer programme comprises instruction sequences arranged to select a programme from a plurality of programmes within a communication network, each programme being composed of a plurality of data series, wherein the network conveys a plurality of different data streams, each data stream conveying one or more programmes, the computer programme arranged to:
issue commands based on manual operations of a plurality of manually operable members, each allowing at least one manual operation; and
select a programme from the plurality of programmes within the network based on the issued commands,
wherein the programme is selected in said selecting step from the one or more programmes within one data stream and the data stream, from which the programme is selected, is selected from the plurality of different data streams in said selecting step, in response to a specific manual operation of one or more manually operable members amongst the plurality of manually operable members without other manual operations of the plurality of manually operable members.

22. A data storage device which can be read by a computer or a microprocessor storing instructions of a computer programme, characterised in that the storage device makes it possible to select a programme from a plurality of programmes within a communication network, each programme being composed of a plurality of data series, wherein the network conveys a plurality of different data streams, each data stream conveying one or more programmes, the instructions of the computer programme arranged to:
issue commands based on manual operations of a plurality of manually operable members, each allowing at least one manual operation; and
select a programme from the plurality of programmes within the network based on the issued commands,
wherein the programme is selected in said selecting step from the one or more programmes within one data stream and the data stream, from which the programme is selected, is selected from the plurality of different data streams in said selecting step, in response to a specific manual operation of one or more manually operable members amongst the plurality of manually operable means without other manual operations of the plurality of manually operable members.
